(19) United States
(12) Patent Application Publication
(10) Pub. No.: US 2008/0125941 A1
(43) Pub. Date: May 29, 2008

(54) OCCUPANT DETECTION AND WARNING SYSTEM FOR OVERHEATED VEHICLES

(75) Inventor: David M. Mitteer, Shelby, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Grand Haven Stamped Products Company, Division of JSJ Corporation

(21) Appl. No.: 11/937,984

(22) Filed: Nov. 9, 2007

Related U.S. Application Data
(60) Provisional application No. 60/867,491, filed on Nov. 28, 2006.

(51) Int. Cl. B60R 21/00; H01H 37/32

(52) U.S. Cl. 701/46; 701/45

(57) ABSTRACT

A control system includes a temperature sensor, an occupant detector, and a responsive circuit for activating a warning horn or to provide ventilation when an occupant is sensed in a dangerously hot passenger compartment. The circuit is passively actuated, such as by using a switch system incorporating a shape memory alloy (SMA) wire or a bimetal switch, in order to control temperatures in the passenger compartment or trunk of vehicles, such as when the vehicle is parked in the sun. The thermal switch actuates an occupant sensor using remote accessory power from the vehicle's battery, yet without creating an unacceptable phantom current drain on the vehicle's battery. Shape memory alloy wire contracts when temperature reaches a predetermined intolerable temperature in a vehicle, thereby closing a normally open switch contact to complete an electrical circuit.

This application claims benefit under 35 U.S.C. §119(e) of provisional application Ser. No. 60/867,491, filed Nov. 28, 2006, entitled OCCUPANT DETECTION AND WARNING SYSTEM FOR OVERHEATED VEHICLES, the entire contents of which are incorporated herein by references.

### BACKGROUND

The present invention relates to occupant detection and warning systems for vehicles, where the system is reactive to dangerous thermal environments in passenger compartments or trunks of the vehicles. Further, the present invention relates to a passive activation system for the same.

The passenger compartments and trunks of modern vehicles quickly become dangerously hot when the vehicles are parked in the sun. Statistics show that hundreds of child fatalities have occurred due to overheated vehicle passenger compartments and trunks causing hyperthermia. Hence, it is potentially important to provide a system capable of warning of a high temperature when occupants are at risk, and/or to provide a system capable of reacting to and relieving the heat. However, in order for a vehicle system to do so in a parked vehicle, the associated electrical circuit must be electrically “hot” and capable of actuation when the vehicle ignition is turned off. This can result in a small but significant electrical drain on the vehicle's battery, sometimes called “phantom current,” which, over time, can result in a dead battery. It is desirable to provide an occupant detection and warning system for reaction to high temperature, yet without creating a significant battery drain. Further, it is desirable to do so with low-cost components, with a non-complex system, and with non-hazardous materials. In regard to non-hazardous materials, it is noted that many thermal switches use liquid mercury to complete an electrical contact for causing electrical power to flow. However, mercury is a toxic metal, such that it is preferable not to use mercury in passenger vehicles. Additionally, motion in a vehicle would result in tripping of conventional mercury switches.

Thus, a method having the aforementioned advantages and solving the aforementioned problems is desired.

### SUMMARY OF THE PRESENT INVENTION

In one aspect of the present invention, a control system for a vehicle having a battery includes a sensing system for sensing a dangerous thermal environment in a vehicle compartment of the vehicle that is potentially hazardous to a vehicle occupant, the sensing system being configured to not draw any current from the vehicle's battery until activated by temperature. An occupant detection system is coupled to the sensing system for detecting the presence of an occupant in the compartment and is operably connected to the sensing system to be activated by the sensing system. A responsive system is provided for responding when both the dangerous thermal environment is sensed and there is an occupant in the compartment, the sensing system and the occupant detection system being configured for automatic operation when the vehicle's ignition is in an off position.

In another aspect of the present invention, an improvement is provided for a vehicle that includes a compartment, a warning component, and ventilation components. The improvement includes a sensor for sensing a dangerous temperature in the vehicle passenger compartment that is potentially hazardous for a vehicle occupant, an occupant detector coupled to the sensor for detecting the presence of an occupant in the passenger compartment, and a responsive circuit for responding when both the dangerous temperature is sensed and there is an occupant in the compartment, the responsive circuit being connected to the sensor, the occupant detector, and at least one of the warning component and the ventilation components.

In another aspect of the present invention, a control system for a vehicle includes a temperature warning system for sensing an unacceptably high thermal environment in a compartment of a vehicle, and an occupant detection system coupled to the warning system for detecting the presence of an occupant in the compartment and for activating the warning system when an occupant is sensed in the compartment when there is an unacceptably high temperature that is potentially hazardous to an occupant.

In another aspect of the present invention, a control system for a vehicle includes a temperature sensing circuit for sensing an unacceptably high thermal environment in a compartment of a vehicle that is potentially hazardous to an occupant. The circuit includes a switch system actuated by shape memory alloy wire for passively causing electrical power to flow.

In another aspect of the present invention, a method includes steps of sensing a high temperature in a compartment of a vehicle, the compartment being one of a passenger compartment and a trunk compartment, detecting the presence of an occupant in the compartment, and passively activating a response system to either relieve the high temperature or warn of the high temperature.

In another aspect of the present invention, a control system for a vehicle includes a switch system that requires no electrical power in a vehicle to detect and respond to a temperature condition in a vehicle compartment. A detection system is activated by the switch system to detect and respond to occupancy of a vehicle compartment. A response system is activated by the detection system to respond to a sequence logic of a temperature condition and occupancy to react to or report this condition.

An object of the present invention is to provide a system that is passive until a hazardous state has been reached, searching the vehicle for any occupants during a hazardous state, and then sends out an alert signal if anyone is detected. For example, the system may remain in a passive state until a temperature of 104 degrees Fahrenheit is reached. When searching for an occupant, the system will use little power, thereby complying with the need for passiveness.

These and other aspects, objects, and features of the present invention will be understood and appreciated by those skilled in the art upon studying the following specification, claims, and appended drawings.

### BRIEF DESCRIPTION OF DRAWINGS

FIG. 1 is an electrical schematic drawing showing a relationship of components.

FIGS. 2-4 are views of vehicle components for a passenger compartment incorporating a circuit providing an occupant detection and warning system for high thermal environments passively using a shape memory alloy, FIG. 2 being a dome light construction, FIG. 3 being an interior rearview mirror construction, and FIG. 4 being an overhead console construction.

FIG. 5 is a logic flow diagram for operation of the circuit of FIG. 1.

FIG. 6 is a side cross-sectional view of an alternative passively-activated thermal switch.

### DETAILED DESCRIPTION OF PREFERRED EMBODIMENTS

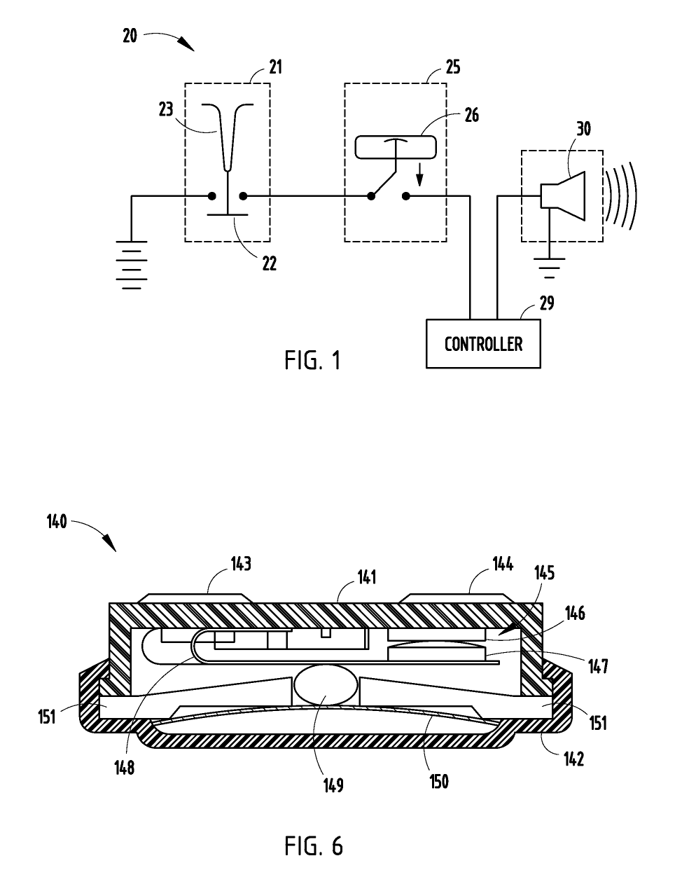

The present illustrated systems and related circuits (FIGS. 1-3) each provide an occupant detection and warning system for reacting to high thermal environments. The system includes a temperature sensing circuit, an occupant circuit, and a reactive component that either warns of the thermal condition or that activates a ventilation component. The system is preferably passively activated, such as by using a shape memory alloy (SMA) wire or bimetal heat-activated thermal switch. For example, the shape memory alloy wire can be used in the circuit to close a thermal switch that temporarily activates remote accessory power (RAP) (such as a window opening motor or a trunk-opening latch) from the vehicle battery, yet without creating an unacceptable phantom current drain on the vehicle's battery. It is contemplated that, when the present switch system is coupled with an electronic controller, the vehicle control circuit can be instructed to perform any number of check routines and/or notify routines, such as checking to see if occupants are present. It should be understood that shape memory alloy wire exhibits a physical change within a narrow temperature change, and can be made to physically contract when temperature reaches a predetermined intolerable temperature in a vehicle. Thus, the SMA wire can be made to close a normally open switch contact in order to complete an electrical circuit to provide remote accessory power to the system. Notably, the phase transformation of SMA material occurs within a relatively narrow temperature band, e.g., 10° F. band width. The band width can be adjusted with adjustment of alloy composition. The length of change for SMA is typically about 5%-8% of its starting length.

As illustrated, a vehicle control system 20 (FIG. 1) includes a sensing circuit 21 (also called a “temperature sensing system”) with a temperature sensitive passive switch 22 (configured to be closed by an SMA wire 23) for sensing a dangerously high thermal environment in a passenger (or trunk) compartment of a vehicle, an occupant detection circuit 25 (also called a “occupant detection system”) with a detector 26 coupled to the sensing system 21 for detecting the presence of an occupant in the passenger compartment (or trunk compartment), and a reactive, responsive system 30 activated when an occupant is in the passenger compartment (or trunk compartment) in a dangerously high thermal environment.

It is contemplated that the occupant detection system can use any number of different detectors, such as a detector selected from any one (or more) of the following: photo sensors, optical sensors, audio sensors, weight sensors, cameras, infrared or other detection means to detect motion, sound, or physical presence of an occupant in a vehicle, individually or in combination. The illustrated circuit includes a controller 29 programmed with logic to selectively actuate various responsive items. Notably, it is contemplated that the controller 29 can be eliminated if desired. However, in a preferred form, the controller is programmed to selectively actuate one or more of the following items in the responsive system 30 depending on the conditions sensed in the vehicle: open windows, ajar (“crack”) windows, activate a panic alarm (noise or light), dial an OnStar™-type system, activate a cooling system or fan, doing one or more of the above, either individually or in combination. Advantageously, the circuit requires no power and is not “active” until the SMA switch is closed via a thermal event (i.e., high temperature in the passenger compartment). Power losses during active thermal environments are minimized through the present remote accessory power (RAP) time out circuit with SMA switch. Thus, the current drain commonly associated with known vehicle electrical circuit architectures is eliminated by the present design. Further, the present circuit is integrated and relatively compact, such that it readily mates with current interior cockpit systems in vehicles.

The present system is passive, and does not require the vehicle's electrical power to be “active,” nor the vehicle's ignition switch to be in an “on” position. Once a thermal condition exists (e.g., an unacceptably high temperature is sensed), the SMA wire undergoes a phase transformation and subsequently contracts in length. The physical change is used to close an electrical switch contact which in turn applies electrical power to the occupant detection system. Thus, if an occupant is found to be in the high temperature, measures are taken to release the heat or notify the vehicle's owner, the public (alarm), or customer service through an OnStar™-type system.

The present system requires low power momentarily only when thermally activated. The controller can be programmed to do additional checks when the SMA switch activates this RAP circuit, such as checking for occupants. By this arrangement, when the ambient temperatures drop during nighttime, the SMA switch opens up and the system is reset. The SMA switch is closed again as the vehicle heats up during the daytime. The system is compact and integrated with sensors, controller, switch, and SMA wire to provide an interior cockpit information center for thermal events.

FIG. 1 illustrates the general circuit layout and relationship of components. FIG. 2 illustrates the circuits in a dome light construction 40. FIG. 3 illustrates the circuits in an interior rearview mirror construction 41. FIG. 4 illustrates the circuits in an overhead console construction 42. It is also contemplated that the present circuits can be incorporated into other components in the passenger compartment of vehicles, such as into the instrument panel, the floor console, the visors, the seats, the interior door panels, and any combination thereof.

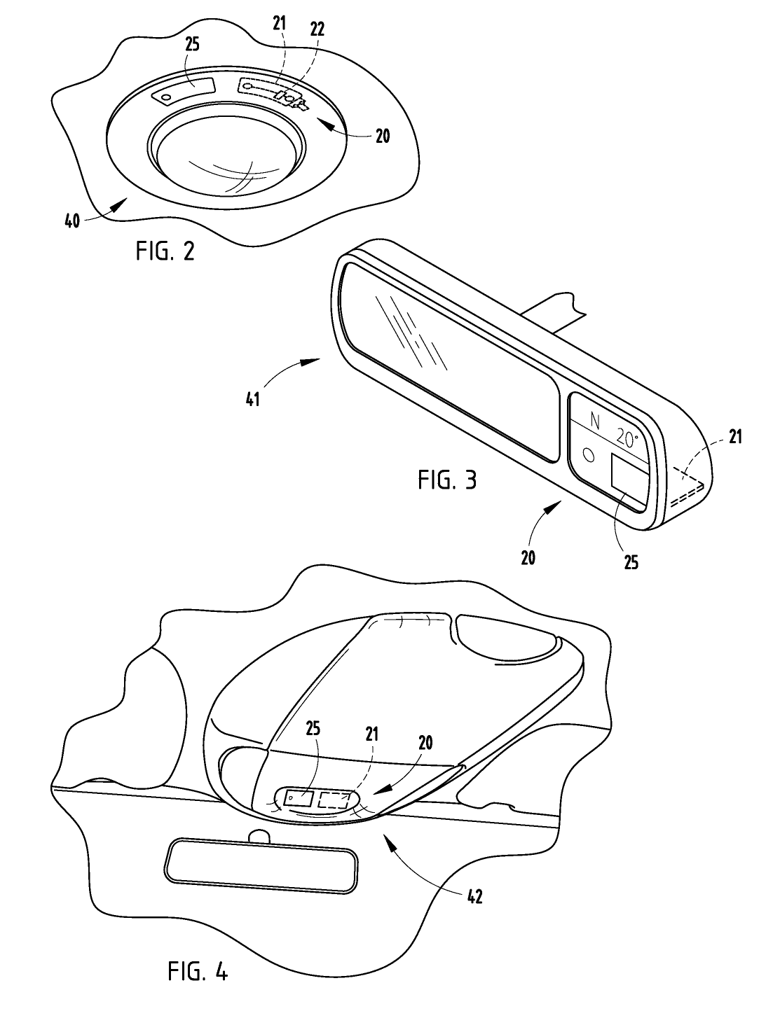

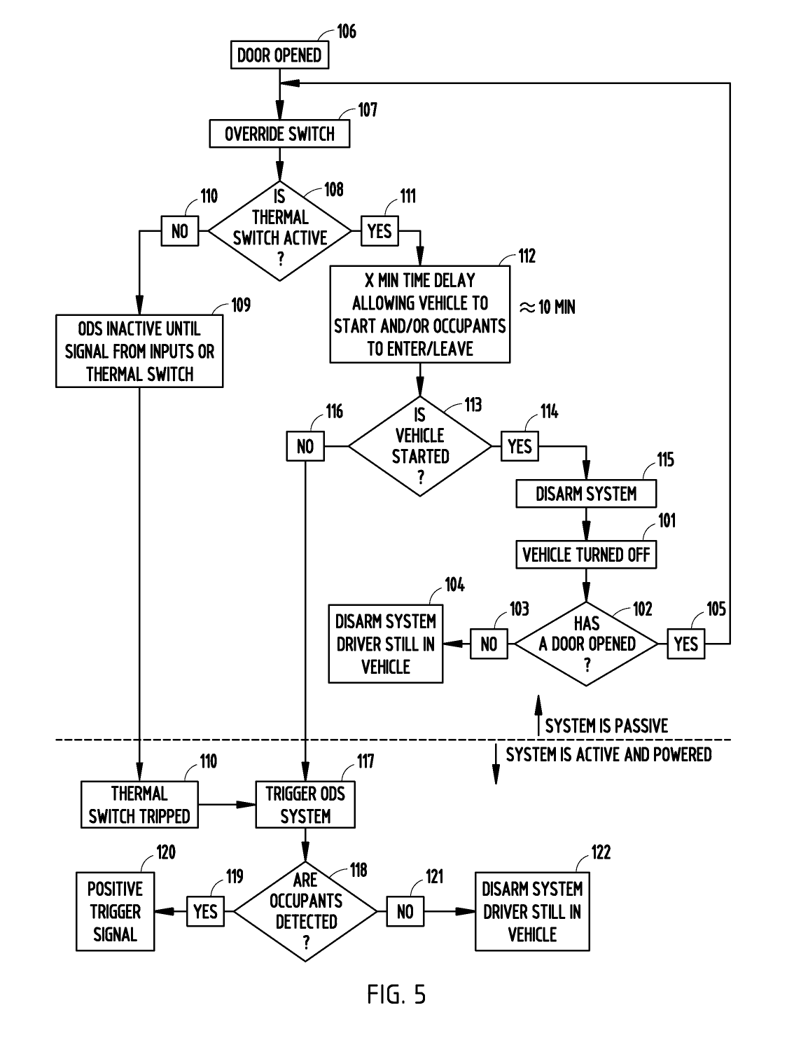

FIG. 5 discloses a logic flow chart of the circuit in FIG. 1. The occupant detection system (ODS system including its controller) receives an input that the vehicle ignition is turned off (step 101), and determines if a door has been opened (step 102). If no (step 103), the ODS system concludes that the driver is still in the vehicle (step 104) and does not operate. If yes (step 105), the system checks to see if the driver door is opened (step 106). There is an override switch (step 107) that can be used if necessary. The system includes a thermal switch (step 108), but remains electrically inactive (step 109) unless the thermal switch is tripped/activated (step 110). If the thermal switch is activated (step 111), there is a time delay (step 112) (such as 10 minutes) allowing the occupants to enter or leave the vehicle. The ODS system receives input if the vehicle is started (step 113). If yes (step 114), the ODS system disarms (step 115) and returns to the step of waiting for the vehicle ignition to be turned off (step 101). If no (step 116), the ODS system is triggered/activated (step 117). Once activated, the ODS system turns on the infrared camera to determine if occupants are present/detected (step 118). If yes (step 119), the ODS system activates the trigger signal (step 120), which can include whatever alarm is programmed into the system, such as notifying the driver via a wireless system, calling a cell phone, setting off an alarm to notify bystanders that assistance is needed, etc. If the infrared camera determines that the driver is still in the vehicle (step 121), the ODS system remains inactive/disarmed (step 122).

FIG. 6 shows an exemplary bimetal thermal switch 140 that is commercially available to the public and that can be used as the thermal switch of the present circuit (FIG. 1). Briefly stated, the exemplary switch 140 includes top and bottom components 141 and 142 forming a housing for the switch. External terminals 143 and 144 are attached to the top component 141, and an internal switch 145 includes a stationary contact 146 connected to the terminal 144, and a second contact 147 connected to terminal 143 and operably supported by a flexible resilient strip 148 supporting the contact 147 in a normally open position. An actuator ball 149 supports the strip 148 on a bimetal disk 150. The disk 150 is captured under flanges 151 but holds the ball 149 in an opening through the flanges 151 at a location adjacent the strip 148/contact 147. When a predetermined thermal temperature is achieved, the disk 150 flexes from convex to concave, moving the ball 140 to cause the contacts 146 and 147 to close. Advantageously, the actuation and reset temperatures of the present system are reliable, repeatable, and relatively close together, as discussed below.

The devices used to accomplish these tasks will be a passive thermal switch, using a bimetallic disk, a passive infrared (PIR) sensor (e.g., a camera), and controller board utilizing two microchips to facilitate the required delays. These devices will all be integrated together and will be placed strategically inside a vehicle, such as inside a vehicle's interior dome light. Since the system will be small enough in size, it should be able to integrate into any vehicle without any major modifications, which greatly increases chances of implantation into newer vehicles and possibly existing vehicles. For larger vehicles or where a system is desired in the passenger compartment and the trunk, multiple cameras and/or triggers can be used.

The illustrated complete system design is comprised of a thermostatic switch used as a passive trigger, an infrared motion sensing camera, and circuit board containing the necessary components needed to carry out the logic. The circuit board also contains light emitting diodes that act as a replacement for the standard dome light bulbs. The entire system is housed within a dome light assembly that can be housed in a new (or existing/old) vehicle, and modified to contain the circuit board along with all its components. In a preferred mode, an internal vehicle temperature of 104 degrees Fahrenheit triggers the thermostatic switch, sending a signal to the logic controller. This signal, combined with inputs from the door(s) and ignition, determines whether the occupant detection (IR Camera) system turns on. Once the camera is turned on, it looks for motion or presence of a person inside the vehicle. If motion is detected, it is deemed there is an occupant inside, and (unless the occupant is the driver) the system sends a signal triggering the desired output. Notably, a preferred camera is an infrared camera so that its sensing capability is shielded by the glass of closed vehicle windows. Thus, passers-by outside the vehicle do not set it off. For this reason, a device/trigger/prevention circuit is not required.

Testing has shown that a suitable passive trigger mechanism is that of a bimetal thermostat switch, as described above. The exemplary switch utilizes a bimetallic disk which switches from convex to concave at a specified temperature. The optimal temperature appears to be about 104 degrees Fahrenheit (40 degrees Celsius), which is accepted by some experts as a danger point for vehicle occupants. The illustrated switch has a temperature tolerance of ±5 degrees Fahrenheit (2.8 degrees Celsius). The switch has a reset temperature of 89 degrees Fahrenheit (34 degrees Celsius), which is within acceptable temperature reset ranges. Notably, it is reasonable to assume that the interior vehicle temperature will drop quickly once the vehicle is driven. With air conditioning, it is expected that it will drop to relatively quickly to a temperature below the 89 degree Fahrenheit limit, thus allowing the system to reset.

At least one known thermostat switch will allow the device to be mounted directly to the logic control circuit board, eliminating the need for wiring and auxiliary mounting. It is noted that air flow characteristics will be need to be considered if, for example, the circuit board and thermostat switch is mounted in the dome light assembly. It is contemplated that light emitting diodes (LEDs) can be used instead of incandescent light bulbs, since LEDs give off considerably less heat. It is also contemplated that a scope of the present invention includes mounting the switch outside of the dome assembly (i.e., sufficiently away from a heat source). Notably, most switches can be ordered with numerous types of terminals and mounting configurations. The flexibility in temperature ranges is also great with possibilities from 35 degrees Fahrenheit to 325 degrees Fahrenheit, allowing the trigger temperature to be modified without capital expense in the event of a trigger temperature discrepancy.

Notably, a bimetal thermal switch can be used instead of the SMA switch to passively activate the system as discussed above. Once activated, the system turns on an infrared camera to look for vehicle occupants. If a vehicle occupant is present, the system does one of the following: 1) generate a wireless signal received by the vehicle owner of the problem, 2) sets off an alarm for bystanders, and/or 3) dial's a cell phone. Other notification systems can be easily added to the system.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is: claimed are defined as follows:

1. A control system for a vehicle having a battery comprising:
a sensing system for sensing a dangerous thermal environment in a vehicle compartment of the vehicle that is potentially hazardous to a vehicle occupant; the sensing system being configured to not draw any current from the vehicle's battery until activated by temperature;
an occupant detection system coupled to the sensing system for detecting the presence of an occupant in the compartment and that is operably connected to the sensing system to be activated by the sensing system; and
a responsive system for responding when both the dangerous thermal environment is sensed and there is an occupant in the compartment, at least the sensing system and the occupant detection system being configured for operation when the vehicle's ignition is in an off position.

2. The vehicle system defined in claim 1, wherein the sensing system includes a thermal switch incorporating a shape memory alloy wire.

3. The vehicle system defined in claim 1, wherein the sensing system includes a thermal switch incorporating a bimetal switch.

4. The vehicle system defined in claim 3, wherein the thermal switch includes an activation temperature within about 20 degrees Fahrenheit of the reset temperature.

5. The vehicle system defined in claim 1, wherein the occupant detection system includes at least one of a photo sensor, an optical sensor, an audio sensor, a weight sensor, a camera, an infrared or other detection means to detect motion, sound, or physical presence of an occupant in a vehicle, individually or in combination.

6. The vehicle system defined in claim 5, wherein the occupant detection system includes at least one infrared camera with sensing capability shielded from motion outside the vehicle by the glass in closed vehicle windows.

7. The vehicle system defined in claim 1, wherein the reactive system includes a controller programmed with logic to selectively actuate one or more of the following: contact a driver through a wireless communication system, call a cell phone, activate a panic alarm intended to notify bystanders of a problem, dial an OnStar™-type system, activate a cooling system, activate a fan, open a window, and/or partially open a window.

8. The vehicle system defined in claim 1, wherein the sensing system includes a temperature sensor circuit, and the occupant detection system includes an occupant sensor circuit for sensing movement of a vehicle occupant other than a vehicle driver.

9. The vehicle system defined in claim 8, including a dome light, and wherein at least one of the temperature sensor circuit and the occupant sensor circuit is located in the dome light.

10. The vehicle system defined in claim 9, wherein the dome light includes a light-emitting diode as a light source.

11. The vehicle system defined in claim 8, including an interior rearview mirror, and wherein at least one of the temperature sensor circuit and the occupant sensor circuit is located in the rear view mirror.

12. The vehicle system defined in claim 8, including an overhead console, and wherein at least one of the temperature sensor circuit and the occupant sensor circuit is located in the overhead console.

13. The vehicle system defined in claim 1, wherein the occupant detection system includes at least two infrared cameras for sensing an occupant.

14. A control system for a vehicle comprising:
a temperature warning system for sensing an unacceptably high thermal environment in a compartment of a vehicle that is potentially hazardous to an occupant; and
an occupant detection system coupled to the warning system for detecting the presence of an occupant in the compartment and for activating the warning system when an occupant is sensed in the compartment at a time when there is an unacceptably high temperature.

15. The vehicle system defined in claim 14, wherein the temperature warning system includes a thermal switch incorporating a bimetal thermal switch.

16. The vehicle system defined in claim 14, wherein the occupant detection system includes at least one of photo sensors, optical sensors, audio sensors, weight sensors, cameras, infrared or other detection means to detect motion, sound, or physical presence of an occupant in a vehicle, individually or in combination.

17. The vehicle system defined in claim 14, wherein the warning system includes a controller programmed with logic to selectively actuate one of the following: open a window, move a window to an ajar position, activate a panic alarm, dial an OnStar-type system, activate a cooling system, and activate a fan.

18. The vehicle system defined in claim 14, wherein the warning system includes a temperature sensor circuit, and the occupant detection system includes an occupant sensor circuit.

19. The vehicle system defined in claim 18, including a dome light, and wherein at least one of the temperature sensor circuit and the occupant sensor circuit is located in the dome light.

20. The vehicle system defined in claim 18, including an overhead console, and wherein at least one of the temperature sensor circuit and the occupant sensor circuit is located in the overhead console.

21. A control system for a vehicle comprising:
a temperature sensing circuit for sensing an unacceptably high thermal environment in a compartment of a vehicle that is potentially hazardous to an occupant; the circuit including a switch system incorporating a shape memory alloy wire for passively causing electrical power to flow in a manner adapted to actuate a response.

22. A method comprising steps of:
sensing a high temperature in a compartment of a vehicle, the compartment being one of a passenger compartment and a trunk compartment;
detecting the presence of an occupant in the compartment; and
passively activating a response system to either relieve the high temperature or warn of the high temperature.
